(19) United States
(12) Patent Application Publication
(10) Pub. No.: US 2005/0265252 A1
(43) Pub. Date: Dec. 1, 2005

(54) Enhancing ephemeral port allocation

(75) Inventors: Dwip N. Banerjee, Austin, TX (US); Venkat Venkatsubra, Austin, TX (US); Richard Perry Youngman, Cedar Park, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 10/855,730

(22) Filed: May 27, 2004

(51) Int. Cl. H04L 12/28

(52) U.S. Cl. 370/252; 709/227; 709/230

(57) ABSTRACT

Methods, systems, and media to sub-divide an ephemeral port range and allocate ports from the sub-divided ephemeral port ranges to facilitate communication with another destination, or target, application are contemplated. Embodiments involve a client computer system having one or more source applications. Embodiments also include hardware and/or software for categorizing transactions based upon characteristics of the transactions. Such categories correspond to categories with which sub-divisions of ephemeral port numbers are assigned. After a transaction is associated with a category, a port number selected from a pool of available port numbers in a sub-division of ephemeral port numbers assigned to that category. In many embodiments, an initial configuration is implemented via a configuration file at the startup of the client computer system. In further embodiments, assignments of ephemeral port numbers to the categories of transactions are dynamically adjusted based upon, e.g., actual usage of the port numbers.

### FIELD OF INVENTION

The present invention is in the field of digital communications. More particularly, the present invention relates to methods, systems, and media to sub-divide an ephemeral port range and allocate ports from the sub-divided ephemeral port ranges based upon, e.g., application loads, anticipated and/or actual load conditions, quality of service, performance guarantees, application starvation, process priority, user identifications, group identifications, process names, and/or the like.

### BACKGROUND

Personal computer systems are well known in the art. They have attained widespread use for providing computer power to many segments of today's modern society. Personal computers (PCs) may be defined as a desktop, floor standing, or portable computer that includes a system unit having a central processing unit (CPU) and associated volatile and non-volatile memory, a display, an input-output device such as a keyboard and/or a mouse, a storage device such as a hard disk storage drive, and, in many instances, a network interface adapter. One of the distinguishing characteristics of these systems is the use of a motherboard or system planar to electrically connect these components together. Examples of such personal computer systems are IBM's PC 300 series, Aptiva series, and Intellistation series.

The widespread use of PCs in conjunction with networks has resulted in a reliance on the network resources, or other computer systems, for, e.g., telecommuting, obtaining news and stock market information, trading, banking, shopping, shipping, communicating in the form of Voice Internet protocol (VoiceIP) and email, as well as other services. For many, PCs represent an essential tool for their livelihood. In today's networked world, the availability and performance of the network is as important as the availability and performance of the personal computer. Thus, it is desirable to minimize loss of productivity by increasing availability of network resources.

Computer systems typically communicate with network resources via local area networks (LANs), such as campus-area networks (CANs) or home-area networks (HANs), or via wide area networks (WANs), such as metropolitan-area networks (MANs) or the Internet. More specifically, each computer system includes or is connected to a network switch to transmit transactions to other computer systems and each operating system running on the multiple computer systems has its own Transmission Control Protocol/Internet Protocol (TCP/IP) stack to coordinate transmission and receipt of the transactions. For instance, when data is being transmitted out of a computer system, the data is first forwarded to the TCP/IP stack, which packages packets of the data with headers. The headers, such as TCP headers or User Datagram Protocol (UDP) headers, identify the application programs running on the source and the destination computer systems that are involved in the transaction.

Unlike TCP, which requires an acknowledgment at the receiving end (handshaking) before the session can begin, UDP just sends out packets in a one-way transmission. UDP is more efficient, for instance, in real-time audio and video transmissions in which lost packets are preferably ignored. The lost packets are preferably ignored in such situations because there is insufficient time to retransmit the packet.

The headers identify sockets for the source and destination computer system, which is a combination of (1) the computer system's IP address and (2) the application's port. If the actual IP address is unknown but the computer system is known by name, a Domain Name System server (DNS server) converts the name into the IP address. In Windows™ networks, for example, a Windows™ Internet Name System server (WINS server) converts NetBIOS names into IP addresses.

Ports are logical numbers assigned to applications that communicate with other computer systems. Some common applications like FTP, SMTP, and HTTP have agreed-upon or well-known port numbers. For example, HTTP applications accessible via the Internet are at port 80, so a Web server may be identified by its IP address and port 80.

On the other hand, an application that is not so common may not have an agreed upon port number. Such applications must have a port number for identification while communicating with another computer system but an operating system, for instance, can assign the port number to the application as needed from a set of unassigned port numbers. The set of unassigned port numbers is often referred to as the ephemeral port range. For example, an accounting application on a client computer may collect transaction information from a bank's web server. The bank's web server may be an http application so the port number for the web server is port 80 and the name of the name of the bank may be “www.banksname.org”. The accounting application does not have an agreed-upon port number so the client computer system assigns the next available port number from the ephemeral range. The accounting application then generates a request for the transaction information including a source socket (the port number and the IP address for the client) and a data packet describing the requested transaction information. The bank's web server can then use the port number and the IP address to transmit the transaction information to the accounting application.

As processing capabilities increase and the reliance on network resources increase, the need for ephemeral ports also increases. Currently, applications essentially race to obtain ephemeral port numbers for communications. Because the ephemeral port range is a finite range that is manually defined and changed, applications that quickly and repeatedly request port number assignments tend to hog the ephemeral port numbers while applications that occasionally need a port number assignment and generate requests for a port number, repeatedly fail and tend to be starved.

Therefore, there is a need for an allocation scheme, and especially a dynamic allocation scheme, for ephemeral port number assignments based upon, e.g., application loads, anticipated and/or actual load conditions, quality of service, performance guarantees, application starvation, process priority, user identifications, group identifications, process names, and/or the like. There is a further need for such an allocation scheme that can adjust the ephemeral port range in response to, e.g., starving one or more applications of port number assignments.

### SUMMARY OF THE INVENTION

The problems identified above are in large part addressed by methods, systems, and media to sub-divide an ephemeral port range and allocate ports from the sub-divided ephemeral port ranges. One embodiment provides a method for assigning port numbers from an ephemeral port number range. The method generally includes determining a category to distinguish transactions that utilize the port numbers from the ephemeral port number range and allocating a subset of the ephemeral port number range to the category to dedicate the subset to transactions that are associated with the category. Embodiments may further involve associating a requestor with the category upon receipt of a request from the requestor for one of the port numbers based upon characteristics associated with the requestor and assigning a port number of the subset associated with the category to the requestor associated with the category based upon availability of the port number in response to associating the requester with the category.

Another embodiment provides an apparatus for assigning port numbers from an ephemeral port number range. The apparatus contemplates a configuration manager to determine a category to distinguish transactions that utilize the port numbers and to allocate of a subset of the ephemeral port number range to the category, dedicating the subset for transactions that are associated with the category; and a port selector to associate a requestor with the category upon receipt of a request from the requestor for one of the port numbers based upon characteristics associated with the requester; and to assign a port number of the subset associated with the category to the requestor associated with the category based upon availability of the port number in response to associating the requestor with the category.

Yet another embodiment provides a machine-accessible medium containing instructions, which when executed by a machine, cause said machine to perform operations. The operations may involve determining a category to distinguish transactions that utilize port numbers from an ephemeral port number range and allocating a subset of the ephemeral port number range to the category to dedicate the subset to transactions that are associated with the category. Many embodiments also involve associating a requestor with the category upon receipt of a request from the requestor for one of the port numbers based upon characteristics associated with the requestor and assigning a port number of the subset associated with the category to the requestor associated with the category based upon availability of the port number.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts an embodiment of a system including a client server and target systems to assign ephemeral port numbers to instances of applications based upon categories of transactions associated with subdivisions of the ephemeral port numbers;

FIG. 2 depicts an embodiment of a five tupple, which is a synch bit packet utilized to initiate a communication channel between an application on a client computer system and an application on a target computer system via Transmission Control Protocol/Internet Protocol (TCP/IP);

FIG. 3 depicts; an embodiment of an apparatus to allocate ports from the sub-divided ephemeral port ranges and to dynamically reallocate ports from the sub-divided ephemeral port ranges based upon a usage of ports within the sub-divided ephemeral port ranges;

FIG. 4 depicts an example of a flow chart to sub-divide an ephemeral port range,

FIG. 5 depicts an example of a flow chart to allocate ports from the sub-divided ephemeral port ranges; and

FIG. 6 depicts an example of a flow chart to dynamically reallocate ports from the sub-divided ephemeral port ranges based upon a usage of ports within the sub-divided ephemeral port ranges.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments, but on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, methods, systems, and media to sub-divide an ephemeral port range and allocate ports from the sub-divided ephemeral port ranges to facilitate communication with another destination, or target, application are contemplated. Embodiments involve a client computer system having one or more source applications that require a port number, or similar designation, for the purposes of communicating with the target application. In some embodiments the client computer system may include both the source and target applications and communication may be implemented via Transmission Control Protocol/Internet Protocol (TCP/IP) on a virtual local area network (LAN). In further embodiments, the client computer system may include the source application(s) and associate the source application(s) with port numbers to communicate with one or more physically distinct computer systems having one or more target applications.

Embodiments include hardware and/or software for categorizing transactions based upon characteristics of the transactions such as characteristics of the source application, the destination application, and/or of the transaction. Such categories correspond to categories with which sub-divisions of ephemeral port numbers are assigned. After a transaction is associated with a category, a port number selected from a pool of available port numbers in a sub-division of ephemeral port numbers assigned to that category. In many embodiments, an initial configuration of the categories and the sub-divisions of the ephemeral port numbers assigned thereto are implemented via a configuration file at the startup of the client computer system. In further embodiments, assignments of ephemeral port numbers to the categories of transactions are dynamically adjusted based upon actual usage of the port numbers, changes to relative priorities assigned to the categories, or other useful related criteria.

Although the following detailed discussion of embodiments of the invention focus on communications via Transmission Control Protocol (TCP) and/or User Datagram Protocol (UDP), any other communications protocols that assign a designation from a finite pool of designations for the purpose of identifying an application that is party to the communication are contemplated. For example, embodiments contemplate any communications protocol that may randomly or systematically assign a designation from a finite set of designations to an application for the purpose of addressing a transaction to that application.

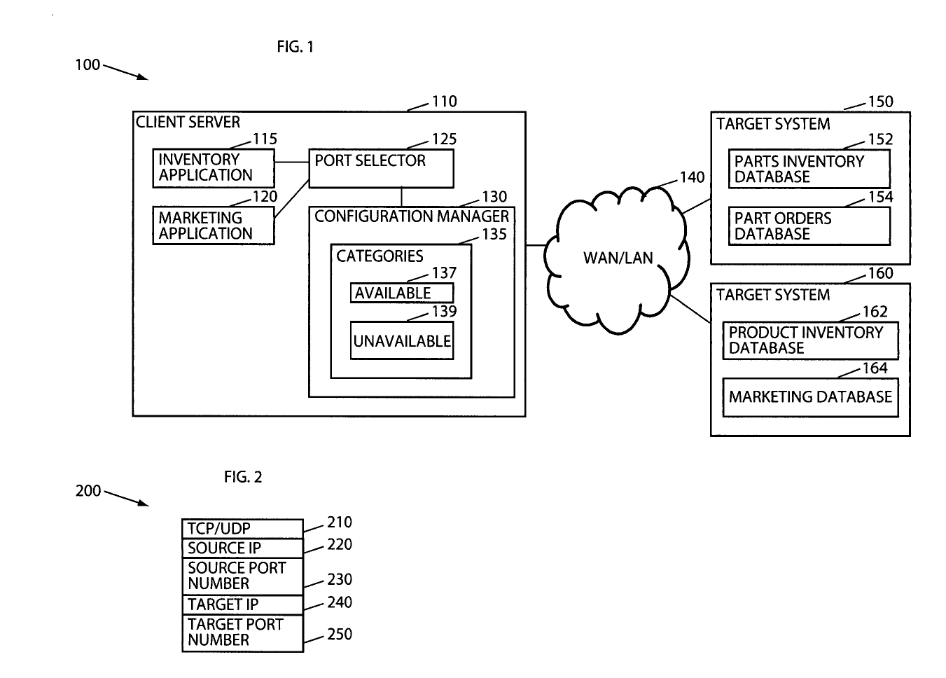

Turning now to the drawings, FIG. 1 depicts an embodiment of a system 100 to sub-divide an ephemeral port range and allocate ports from the sub-divided ephemeral port ranges to facilitate communication with another destination, or target, application. More specifically, system 100 may include client server 110, wide area network/local area network (WAN/LAN) 140, target system 150, and target system 160. Client server 110 may be a server system such as for an office, an Internet provider service (ISP), a partition of a logically partitioned system, or the like. Client server 110 may be designed to execute applications such as an inventory application 115 and a marketing application 120 to gather data for such applications to provide services to clients. The clients may communicate with client server 110 through a physical network like WAN/LAN 140 or a virtual network such as a virtual LAN implemented on client server 110.

Client server 110, for the present illustration, includes inventory application 115, marketing application 120, a port selector 125, and a configuration manager 130. Inventory application 115 may represent multiple instances of inventory application 115 each designed to periodically retrieve data related to part inventories from a manufacturing facility, target system 150, and product inventories from a distribution facility, target system 160, to provide clients with data to determine the current product inventory, potential product inventory based upon current part inventories, and potential product inventories based upon part orders. More specifically, each instance of inventory application 115 may communicate with target system 150 six times per hour each hour and target system 160 six times each hour to insure that the product and part inventories accurately reflect the actual inventories and part orders reflect currently contracted part orders.

Marketing application 120 may represent one or more instances of marketing application 120 to track sales, completed transactions, and transactions to be completed based upon current and future product inventories. Marketing application 120 accesses target system 160 periodically to maintain updated information for the clients of client server 110. For instance, each instance of marketing application 120 may periodically communicate with target system 160. More specifically, marketing application 120 may transmit a synch bit packet to target system 160 to initiate communication between marketing application 120 and marketing database 164. The synch bit packet may have a five tupple.

Referring both to FIG. 1 and FIG. 2, there is shown synch bit packet 200, a five tupple designed to initiate a communications channel between an application on a client computer system such as client server 110 and a marketing database 164 application on a target computer system such as target system 150 or 160. More specifically, synch bit packet 200 includes at least the information needed to establish a communication channel and synch bit packet 200, as shown, is specifically designed for TCP/IP. Synch bit packet 200 includes an indication of a protocol type 210, which may be one or more bits to describe the communication protocol requested as TCP or UDP. The address for, e.g., an instance of marketing application 120 is described by a source IP address 220 and a source port number 230. The source IP address 220 identifies client server 110 uniquely for WAN/LAN 140 and the source port number 230 describes marketing application 120, or an instance thereof, uniquely. In addition, synch bit packet 200 includes an address for the target application, target IP address 240 and target port number 250. Similarly, target IP address 240 describes, e.g, target system 160 uniquely for WAN/LAN 140 and target port number 250 describes, e.g., marketing database 164 uniquely within target system 160.

Both the instances of inventory application 115 and the instances of marketing application 120 may procure a port number from an ephemeral port range of client server 110. Neither the instances of inventory application 115 and the instances of marketing application 120 may be assigned a permanent port number because the number of instances of each and thus the number of port numbers required for each may depend upon the number of clients logged into inventory application 115 and/or marketing application 120. Further, the number of potential instances may exceed the number of ephemeral port numbers.

Port selector 125 couples with configuration manager 130 to determine port numbers to assign to instances of inventory application 115 and marketing application 120. More specifically, configuration manger 130, upon start up of client server 110, loads an initial configuration for the ephemeral port range of client server 110. The initial configuration includes an initial designation of categories for transactions and an initial assignment of sub-ranges of the ephemeral port range to the categories, designating port numbers for use by transactions that fall within the categories. For example, in one embodiment, the ephemeral port number range may include port numbers 32768-65535 and an initial configuration may include three categories: inventory instances, marketing instances, and other applications. The inventory instances category may be assigned, e.g., port numbers 32768-48000 for use by instances of inventory application 115. The marketing instances category may be assigned, e.g., port numbers 48001-62000 for use by instances of marketing application 120. And the other applications may be assigned, e.g., port numbers 62001-65535 for all other applications, or instances thereof.

Port selector 125, for a port number matches the request to a category based upon a characteristic of the transaction. In the present embodiment, upon receiving a request by, e.g., an instance of inventory application 115, assigns the next available port number in the range of ephemeral port numbers assigned to the inventory instances, port numbers 32768-48000. A pointer is set to the next available port number and each time an available port number is located and assigned, the pointer is set to point at that port number.

Further criteria may be used to distinguish categories of transactions in addition to or instead of the identity of the application. For instance, the categories may be created based upon application loads, quality of service (QOS), performance requirements, performance requirements, priorities associated with transactions based upon the source or target systems, the number of failed attempts to obtain a port number associated with a requester, and/or other characteristics that distinguish transactions. In particular, a port number usage monitor may track actual application loads, a QOS module may categorize requests, or bind calls, for port numbers to provide service in accordance with QOS standards. QOS standards are a family of evolving Internet standards designed to provide preferential treatment to certain types of IP traffic.

In addition, categories may be distinguished based upon performance requirements demanded by certain applications or types of transactions. For example, a real-time video/ and/or transmission may require a minimum bandwidth depending upon the resolution of the video and/or sound quality so the categories enforced by configuration manager 130 may provide preferential treatment to real-time video and audio transmissions.

Priorities associated with transactions, as with performance requirements and QOS, may provide preferential treatment to transactions for other reasons such as the number of clients having access to an application, the level of service purchased by certain clients, and other possible criteria for offering preferential treatment. The number of failed attempts for obtaining a port number may be counted for each requester, or source application, or groups of applications to prevent starvation of certain applications.

Configuration manager 130, in some embodiments, offers dynamic adjustment of categories and assignments of port numbers to categories. In particular, a usage monitor may determine that, although 70% of the ephemeral port numbers are assigned to instances of inventory application 115, only 50% of the port numbers actually being assigned are to instances of inventory application 115. Thus, configuration manager 130 may monitor the usage and respond to such a discrepancy by re-allocating a portion of the port numbers assigned to instances of inventory application 115 to other categories.

WAN/LAN 140 is a network connection to couple client server 110 with target systems 150 and 160 to facilitate communications. In some embodiments, WAN/LAN 140 may include a network in an office coupled via Ethernet, optical media like OptiConnect, a wireless network, or the like. In several embodiments, LAN/WAN 242 also couples with the Internet via a cable modem, a digital subscriber line (DSL), a T1 line, a T3 line, or the like. In further embodiments, WAN/LAN 140 may include a network of temporary connections such as connections via a telephone system.

Target systems 150 and 160 may include any type of computer systems or data storage systems having a TCP/IP interface for receiving and transmitting transactions. Target system 150 includes a parts inventory database 152 and a part orders database 154. Parts inventory database 152 and a part orders database 154 may be databases local to a manufacturing facility to track parts, available and on order, for manufacturing one or more products. Parts inventory database 152 and a part orders database 154 may be assigned the same port numbers, 52 and 53, respectively, each time target system 150 starts up. For instance, upon start up, parts inventory database 152 and a part orders database 154 may request port numbers, 52 and 53, respectively. If parts inventory database 152, for example, does not receive an assignment for port 52, execution of parts inventory database 152 may terminate. The data is collected locally and transmitted, upon request, to client server 110 for analysis. Advantageously, when the applications receive the same port numbers each time target system 150 starts up, instances of the inventory application 115 know the port number for the application so the synch bit packet may be generated upon assignment of an ephemeral port number.

Similarly, target system 160 includes a product inventory database 162 and a marketing database 164 local to a distributorship and be assigned the same port numbers, 52 and 53, respectively, each time target system 160 starts up. The product inventory database 162 is designed to collect inventory shipments to and from the distributorship as well as lots of the products identified as being in storage at the distributorship. The marketing database 164 is designed to gather data from sales sites and both databases transmit the collected data, upon request, to client server 110 for analysis.

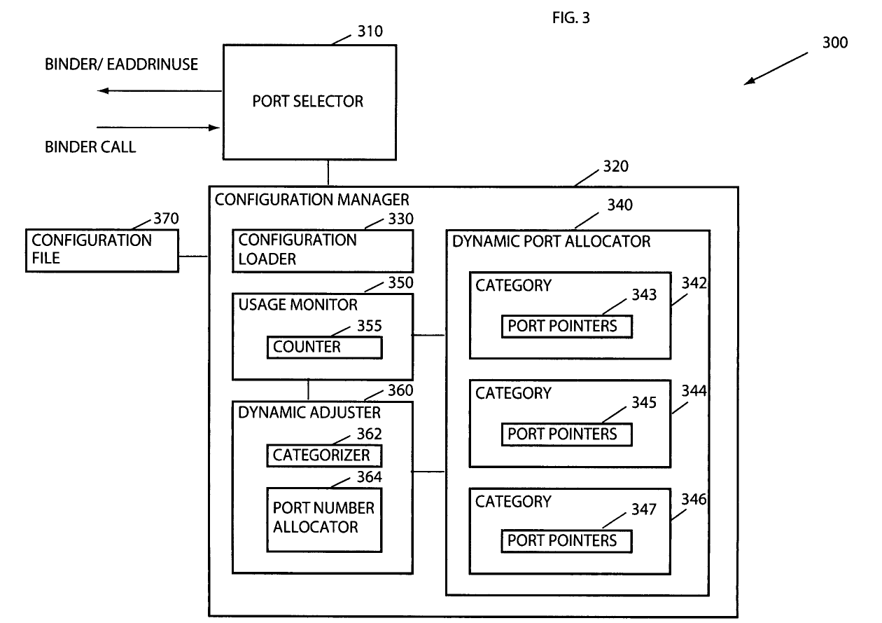

FIG. 3 depicts an embodiment of an apparatus 300 to allocate ports from sub-divisions of an ephemeral port range and to dynamically reallocate ports from the sub-divisions based upon usage of the ports. Apparatus 300 includes a port selector 310, a configuration manager 320, and a configuration file 370. Port selector 310 may receive a binder call from an application requesting assignment of a port number from an ephemeral port range. Based upon the requester or a characteristic of the intended transaction as indicated by the binder call, a category associated with a subdivision of the ephemeral port range is associated with the requestor. Port selector 310 then searches for the next available port number in the subdivision. For instance, the port numbers may be searched sequentially in an ascending or descending order until an available port number is found. When an available port number is located, the port number is assigned to the application for a communication session. Upon completion of the communication session, the port number is then released and is available for a subsequent communication session associated with the category. On the other hand, when no available port number is located in the subdivision of port numbers associated with the category, an indication such as an EADDRIUNUSE error is returned to the requester.

Port selector 310 couples with configuration manager 320 to locate an available port, bind the port number to transport layer and physical layer structures and circuitry, and assign the port number to the requester. Configuration manager 320 is designed to maintain port number allocations to categories and, in the present embodiment, dynamically adjust port number allocations to the categories based upon usage of port numbers. In particular, configuration manager 320 includes configuration loader 330, dynamic port allocations 340, usage monitor 350, and dynamic adjuster 360.

Configuration loader 330 may load an initial configuration of categories and port number allocations to those categories at system start up from a non-volatile memory, configuration file 370, such as via a flash basic input-output system (BIOS). Configuration loader 330 may store the initial configuration in dynamic port allocations 340. For example, an initial configuration may be manually defined and stored in a flash memory. The initial configuration categories may be defined based upon anticipated application loads, application priorities, transaction type priorities, or the like. Each of the categories are then allocated a subdivision of the ephemeral port range based upon the relative application loads, priorities, etc. between the categories. For instance, a category 342 may be defined for applications expected to utilize over ten percent of the port numbers in the ephemeral port range, a category 344 may be defined for applications expected to utilize between five percent and ten percent of the port numbers, and a category 346 may be defined for applications expected to utilize less then five percent of the port numbers. Initial allocations of port numbers may be made by associating port numbers, or pointers, to each category.

Dynamic port allocations 340 may reside in a volatile memory such as random access memory (RAM) of a cache, a main memory chip, or other available memory. Advantageously, dynamic port allocations 340 can then be accessed quickly for assigning port numbers to requestors or adjusting the ephemeral port allocations to the categories.

Dynamic port allocations 340 couples with usage monitor 350 and dynamic adjuster 360 for dynamic modifications of allocations of the ephemeral port range to categories 342, 344, and 346. In particular, usage monitor 350 is designed to monitor or sample port number allocations to determine a representative number of port numbers being utilized by each category. The representative number may be, for instance, an average number from more than one samples of port numbers, an instantaneous number of port numbers being utilized per category, or other number related to the actual use of port numbers in each of the categories.

In some embodiments, usage monitor 350 also includes a counter 355 to track the number of EADDRINUSE errors received by a requestor in response to bind calls. Such a counter can advantageously be implemented to prevent starvation of any particular category of transactions. In further embodiments, the counter may track, for instance, the number of port assignment requests and usages by a requester to determine whether the category association for the requestor should be modified.

Dynamic adjuster 360 couples with usage monitor 350 to implement dynamic re-allocations of ephemeral port numbers between categories or into new categories based upon actual usage of the port numbers. Dynamic adjuster 360 includes categorizer 362 to modify category assignments for requesters and port number allocator 364 to re-allocate port numbers between categories 342, 344, and 346. For instance, counter 355 may track the number of port numbers utilized by a requestor in category 346. After a large number of clients log into the application, the count in counter 355 may indicate that the application is utilizing more than five percent of the ephemeral port numbers on a regular basis so categorizer 362 may reassign the application to category 344. Similarly, if a category such as category 342 is allocated significantly more ephemeral port numbers than are being used according to usage monitor 350, port number allocator 364 may re-allocate a range of port numbers allocated to category 342 to one or more other categories.

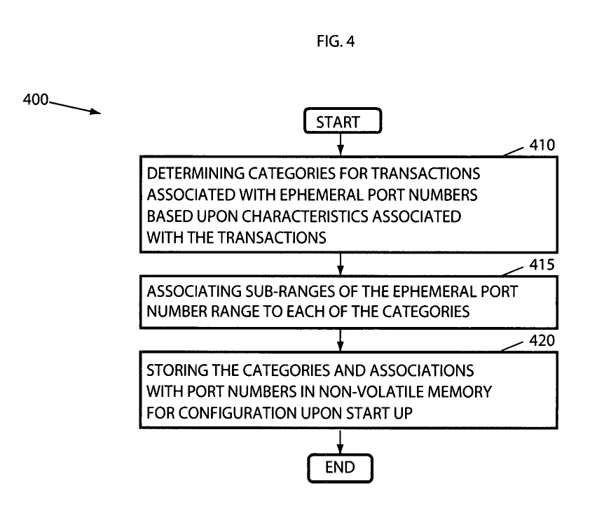

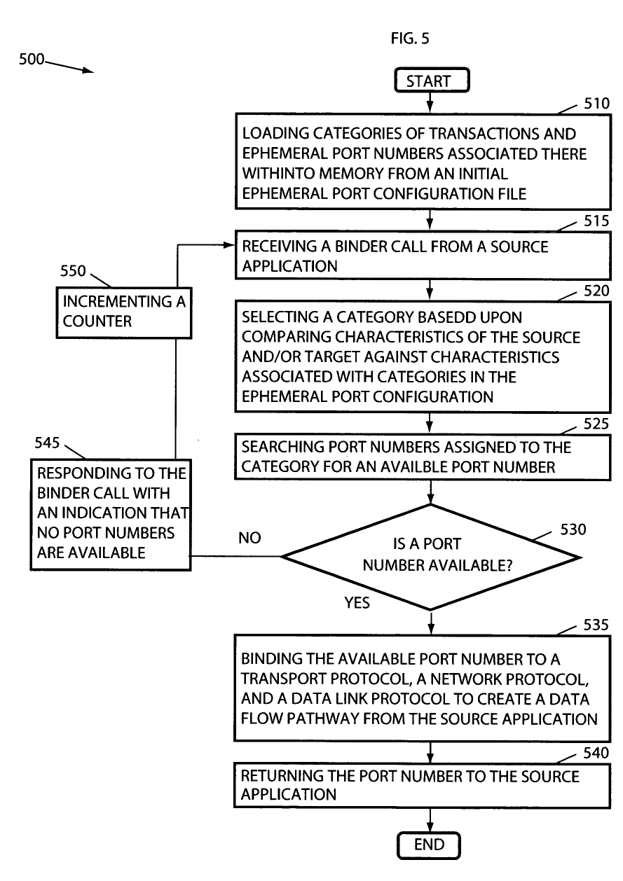

Referring now to FIG. 4, there is shown an example of a flow chart 400 for generating a configuration file defining initial categories and port number allocations. Flow chart 400 begins with determining categories of transactions associated with ephemeral port numbers based upon characteristics associated with the transactions (element 410). In particular, categories may be manually defined based upon observed or anticipated application loads, QOS, performance requirements, performance guarantees, priorities, or other characteristics associated with transactions between source and target applications.

After the categories are defined, sub-ranges of the ephemeral port range are allocated to each of the categories (element 415). The number of port numbers in the sub-ranges of the ephemeral port range that are assigned to a category may be based on both a weight associated with the characteristic and the anticipated or observed usage by applications associated with the category.

The categories and associations between the port numbers and categories are then stored in non-volatile memory for configuration of the system upon start up (element 420). For example, the configuration may reside in flash memory having initial program loads (IPLs) for system startup.

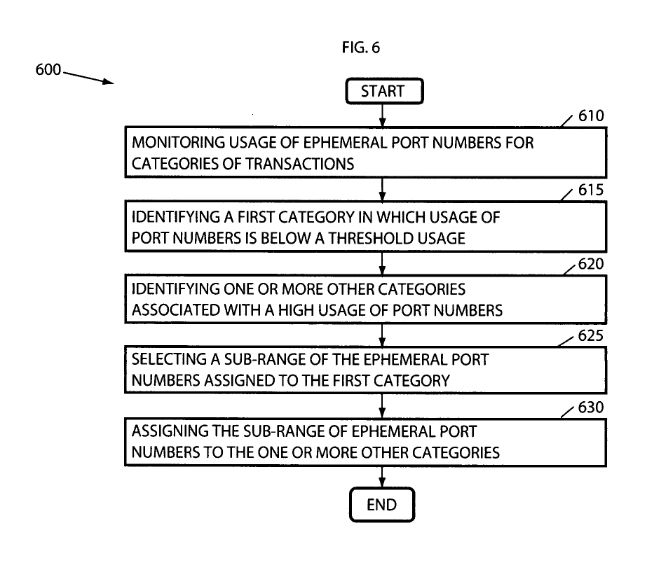

Referring now to FIG. 5, there is shown an example of a flow chart 500 to allocate ports from the sub-divided ephemeral port ranges. Flow chart 500 begins with loading categories of transactions and ephemeral port numbers associated therewith into memory from an initial ephemeral port configuration file (element 510). In particular, categories may be defined and ephemeral port number ranges associated with each category as a preliminary set up during system start up. Element 510 finds the initial configuration and loads the configuration into a memory location for quick and convenient access for assigning the ephemeral port numbers. In addition, as will be discussed in relation with FIG. 6, the version in memory may be dynamically modified based upon, e.g., actual usage of port numbers within one or more of the categories.

After start up, a source application may transmit a binder call (element 515) requesting that an ephemeral port number be assigned to the application so the application can communicate with a target application. Based upon the binder call, the transaction for which the port number is being requested is categorized. The transaction may be categorized based upon one or more of a number of characteristics such as the identity of the source application and/or the target application. The transaction may be categorized by comparing the characteristics to characteristics utilized to distinguish categories of the ephemeral port numbers (element 520).

Upon associating the transaction with a category, ephemeral port numbers associated with the category are searched to locate an available port number (element 525). If a port number within the set of ephemeral port numbers associated with the category, the port number is bound to a transport protocol, network protocol, and data link protocol to create a data flow pathway from the source application (element 535). The port number is then returned to the source application (element 540) to facilitate communication with the target application. For example, a synch bit packet may then be generated. The synch bit packet may indicate the protocol for the communication channel such as TCP or UDP. The synch packet may also provide the source application's unique address including the source IP address, e.g., 9.41.86.61, and the assigned port number such as 34999, and the target application's unique address including the target IP address, e.g., 1.1.1.1, and the target application's port number, e.g., 52.

The synch bit packet is then transmitted to the target application to initiate the communications channel. Upon receipt of the synch bit packet, an acknowledgement is returned which offers a number of link or channel parameters. The source application compares the parameters with acceptable or workable parameters, e.g., parameters within the communication limits of the protocols bound to the assigned ephemeral port number. If the parameters are acceptable, the source application returns an acknowledgement accepting the communication channel. Otherwise, the communication channel may be rejected. The target application then also responds with an acknowledgement either confirming the establishment of the communications channel or the rejection of the channel, completing the interaction between the source application and the target application.

If no port numbers are available for the category associated with the transaction, the response to the source application's binder call indicates that no port numbers are available (element 545). Some embodiments further employ a counter to monitor the number of such responses that are returned overall, to groups of applications, and/or to individual applications. The counter is incremented (element 550) and the port selector awaits another binder call from a source application at element 515. The count may then be utilized in a manner such as the manner described via FIG. 6 to prevent starvation of any particular transactions.

Referring now to FIG. 6, there is shown an example of a flow chart 600 to dynamically reallocate ports from the sub-divided ephemeral port ranges based upon a usage of ports within the sub-divided ephemeral port ranges. Flow chart 600 begins by monitoring usage of ephemeral port numbers for one or more of the categories established for transactions (element 610). Usage of the port numbers may be monitored by, e.g., sampling the number of available port numbers or unavailable port numbers for each category periodically.

A category may then be identified as being associated with a port number usage that is below a threshold usage (element 615). In the present embodiment, such a condition instigates a re-allocation of port numbers from the category having low usage to a category associated with a high port number usage. In further embodiments, the re-allocation may not be triggered unless one or more other categories are also identified as having a usage above corresponding high threshold usage (element 620).

In further embodiments, if monitoring identifies a that category appears to use a smaller percentage of the port numbers associated therewith relative to other categories, port numbers may be re-allocated from that category to other categories. In some embodiments, if a category receives more than a threshold number of EADDRINUSE errors, indicating that no port number is available for assignment, port numbers may be re-allocated to the category based upon, relative usage of ranges of ephemeral port numbers assigned to other categories.

Once one or more categories are identified with a low usage of port numbers and one or more are identified with a high usage or port numbers, a sub-range of ephemeral port numbers assigned to the low usage category is selected for re-allocation (element 625). The sub-range is then allocated to the one or more other categories (element 630) identified with a high usage of port numbers, advantageously adapting to changing conditions, such as the number of connected clients, dynamically.

One embodiment of the invention is implemented as a program product for use with a computer system such as, for example, the system 100 shown in FIG. 1. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., hard-disk drive or floppy disks within a diskette drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates sub-division of an ephemeral port range and allocation ports from the sub-divisions based upon, e.g., application loads, anticipated and/or actual load conditions, quality of service, performance guarantees, application starvation, process priority, user identifications, group identifications, process names, and/or the like. It is understood that the form of the invention shown and described in the detailed description and the drawings are to be taken merely as examples. It is intended that the following claims be interpreted broadly to embrace all the variations of the example embodiments disclosed.

1. A method for assigning port numbers from an ephemeral port number range, the method comprising:
determining a category to distinguish transactions that utilize the port numbers from the ephemeral port number range;
allocating a subset of the ephemeral port number range to the category to dedicate the subset to transactions that are associated with the category;
associating a requester with the category upon receipt of a request from the requester for one of the port numbers based upon characteristics associated with the requestor; and
assigning a port number of the subset associated with the category to the requestor associated with the category based upon availability of the port number in response to associating the requestor with the category.

2. The method of claim 1, further comprising re-allocating one or more of the port numbers from another category to the category to attenuate starvation of applications associated with the category.

3. The method of claim 1, further comprising re-allocating one or more of the port numbers from another category to the category based upon high usage of the subset.

4. The method of claim 1, further comprising re-allocating one or more of the port numbers from the category to another category based upon low usage of the subset.

5. The method of claim 1, wherein determining comprises loading the category from a configuration file at start up.

6. The method of claim 1, wherein determining comprises adding the category in response to a usage of the port numbers by an application, wherein the usage exceeds a usage threshold.

7. The method of claim 1, wherein allocating comprises sub-dividing the ephemeral port number range based upon an anticipated usage of the port numbers by applications associated with the category.

8. The method of claim 1, wherein assigning comprises binding the port number to a protocol to create a pathway for data from the requester to a target application.

9. The method of claim 1, wherein assigning comprises searching through the subset for a next available port number, wherein the next available port number is the port number.

10. An apparatus for assigning port numbers from an ephemeral port number range, the apparatus comprising:
a configuration manager to determine a category to distinguish transactions that utilize the port numbers and to allocate of a subset of the ephemeral port number range to the category, dedicating the subset for transactions that are associated with the category; and
a port selector to associate a requester with the category upon receipt of a request from the requestor for one of the port numbers based upon characteristics associated with the requestor; and to assign a port number of the subset associated with the category to the requestor associated with the category based upon availability of the port number in response to associating the requester with the category.

11. The apparatus of claim 10, wherein the configuration manager comprises a usage monitor to monitor an actual usage of the port numbers in the subset and couples with a dynamic adjuster to re-allocate one or more of the port numbers between the category and another category based upon the actual usage of the subset.

12. The apparatus of claim 10, wherein the configuration manager comprises a counter to count failures by the port selector to provide a port number in response to requests by the requestor to attenuate starvation of the requester.

13. The apparatus of claim 10, wherein the configuration manager comprises a configuration loader to load the category from a configuration file at start up.

14. The apparatus of claim 10, wherein the configuration manager comprises a dynamic adjuster to add the category in response to a usage of the port numbers by one or more applications, wherein the usage exceeds a usage threshold.

15. The apparatus of claim 10, wherein the port selector is designed to bind the port number to a protocol to create a pathway for data from the requestor to a target application.

16. The apparatus of claim 10, wherein the port selector is designed to search through the subset for a next available port number, wherein the next available port number is the port number.

17. A machine-accessible medium containing instructions, which when executed by a machine, cause said machine to perform operations, comprising:
determining a category to distinguish transactions that utilize port numbers from an ephemeral port number range;
allocating a subset of the ephemeral port number range to the category to dedicate the subset to transactions that are associated with the category;
associating a requester with the category upon receipt of a request from the requestor for one of the port numbers based upon characteristics associated with the requestor; and
assigning a port number of the subset associated with the category to the requestor associated with the category based upon availability of the port number.

18. The machine-accessible medium of claim 17, wherein the operations further comprise re-allocating one or more port numbers from another category to the category to attenuate starvation of applications associated with the category.

19. The machine-accessible medium of claim 17, wherein the operations further comprise re-allocating one or more port numbers from another category to the category in response to high usage of the subset.

20. The machine-accessible medium of claim 17, wherein the operations further comprise re-allocating one or more port numbers from the category to another category in response to low usage of the subset.
